(19) United States
(12) Patent Application Publication
(10) Pub. No.: US 2026/0121229 A1
(43) Pub. Date: Apr. 30, 2026

(54) SECONDARY BATTERY AND METHOD OF MANUFACTURING THE SECONDARY BATTERY

(71) Applicant: SAMSUNG SDI CO., LTD., Yongin-si (KR)

(72) Inventors: Dong Hyun KIM, Yongin-si (KR); Ye Jin SEO, Yongin-si (KR); Eun Jeong MOON, Yongin-si (KR)

(21) Appl. No.: 19/217,069

(22) Filed: May 23, 2025

(30) Foreign Application Priority Data
Oct. 31, 2024 (KR) 10-2024-0151707

(51) Int. Cl. H01M 50/46; H01M 50/403

(52) U.S. Cl. CPC H01M 50/46; H01M 50/403

(57) ABSTRACT

The present disclosure provides a secondary battery, in which a separator is fixed by sewing to restrict movement of the separator, thereby improving electrical stability of the secondary battery, and a method of manufacturing the secondary battery. The secondary battery may include an electrode assembly including a positive electrode plate, a negative electrode plate, and a separator, and a fixing part provided at an end of the electrode assembly, with the fixing part being configured to sew and fix the separator at a position separated from the positive electrode plate and the negative electrode plate.

### CROSS-REFERENCE TO THE RELATED APPLICATION

The present application claims priority to and the benefit of Korean Patent Application No. 10-2024-0151707, filed on Oct. 31, 2024, in the Korean Intellectual Property Office, the entire disclosure of which is incorporated herein by reference.

### BACKGROUND

### 1. Field

Embodiments relate to a secondary battery and a method of manufacturing the secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

Aspects of some embodiments of the present disclosure provide a secondary battery in which there is a reduced risk of short circuit by restricting movement of a separator, and a method of manufacturing the secondary battery.

Other aspects of some embodiments of the present disclosure provide a secondary battery in which movement of a separator is restricted in the event of an external impact.

However, the technical problems to be achieved in the embodiment of the disclosure are not limited to the technical problems mentioned above, and other technical problems not mentioned herein will be clearly understood from the following description by those skilled in the art to which the disclosure belongs.

According to some embodiments, a secondary battery includes: an electrode assembly including a positive electrode plate, a negative electrode plate, and a separator; and a fixing part provided at an end of the electrode assembly, with the fixing part being configured sew and fix the separator at a position separated from the positive electrode plate and the negative electrode plate.

In some embodiments, the electrode assembly may be a stack type or wound type.

In some embodiments, the fixing part includes a heat-resistant thread.

In some embodiments, the heat-resistant thread may be made of aramid fibers, polyimide fibers, or glass fibers.

In some embodiments, the electrode assembly includes a plurality of stacked separators, and the fixing part sews and thereby fixes the separators in a vertical direction.

In some embodiments, the fixing part may include a first fixing part disposed between an upper end of the negative electrode plate and an upper end of the separator to sew and fix the separator.

In some embodiments, the first fixing part may include a suture line in a width direction of the electrode assembly and fixes the separator.

In some embodiments, the first fixing part may further include a second suture line below the first suture line that further fixes the separator.

In some embodiments, the fixing part may include a first fixing part disposed between an upper end of the negative electrode plate and an upper end of the separator to sew and fix the separator and a second fixing part disposed between a lower end of the negative electrode and a lower end of the separator to sew and fix the separator.

In some embodiments, the second fixing part may include a suture line in a width direction of the electrode assembly to fix the separator.

In some embodiments, the second fixing part may further include another suture line that further fixes the separator.

According to some embodiments, a method of manufacturing a secondary battery includes: an alignment process of installing a guide jig outside an electrode assembly comprising a positive electrode plate, a negative electrode plate, and a separator so that the guide jig restricts movement of the electrode assembly; a first guide installation process of installing a first guide to a position facing a first end of the electrode assembly in a longitudinal direction; a first sewing process of sewing and fixing a first side of the separator in the longitudinal direction, the first side being spaced from the positive electrode plate and the negative electrode plate; a second guide installation process of installing a second guide to a position facing a second end of the electrode assembly in the longitudinal direction; and a second sewing process of sewing and fixing the second side of the separator, in the longitudinal direction, the second side being spaced from the positive electrode plate and the negative electrode plate.

In some embodiments, the method may further include, before the first sewing process, a first visual inspection process of visually inspecting the first and second sides of the electrode assembly.

In some embodiments, the method may further include, after the second sewing process, a second visual inspection process of visually inspecting the first and second sides of the electrode assembly.

In some embodiments, the guide jig may be provided on at least one of sides of the electrode assembly in a width direction or both sides of the electrode assembly in the longitudinal direction.

In some embodiments, the first guide may be a plate extending in a vertical direction that moves vertically to guide the electrode assembly.

In some embodiments, in the first sewing process, a part of the separator disposed in an area between an end of the negative electrode plate in the longitudinal direction and an end of the separator in the longitudinal direction may be sewn.

In some embodiments, in the second sewing process, the separator disposed on an area between an end of the negative electrode plate in the longitudinal direction and an end of the separator in the longitudinal direction may be sewn.

In some embodiments, in the first sewing process and the second sewing process, a sewing line, in which a heat-resistant thread is disposed, and a separation line, oi which the heat-resistant thread is not disposed, may be alternately formed.

In some embodiments, in the first sewing process and the second sewing process, a sewing line, in which a heat-resistant thread is disposed, may be formed in a width direction of the separator.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view of a secondary battery according to embodiments;

FIG. 2 is a perspective view of a state in which an electrode assembly is separated from a case according to embodiments;

FIG. 3 is a plan view of a state in which the electrode assembly is fixed by a fixing part according to embodiments;

FIG. 4 is an exploded perspective view of the electrode assembly according to embodiments;

FIG. 5 is a side view of a state in which the electrode assembly is fixed by the fixing part according to embodiments;

FIG. 6 is a side view of a state in which a first fixing part is provided according to embodiments;

FIG. 7 is a side view of a state in which a second fixing part is provided according to embodiments;

FIG. 8 is a perspective view of a state in which the electrode assembly is aligned by a guide jig according to embodiments;

FIG. 9 is a perspective view of a state in which a first area is inspected by a vision inspector according to embodiments;

FIG. 10 is a perspective view of a state in which one side of the electrode assembly in a longitudinal direction is aligned by a first guide according to embodiments;

FIG. 11 is a perspective view of a state in which the electrode assembly on the first area is sewn by a sewing machine according to embodiments;

FIG. 12 is a perspective view of a state in which the first fixing part is provided in the first area according to embodiments;

FIG. 13 is a perspective view of a state in which the electrode assembly on a second area is sewn by the sewing machine according to embodiments;

FIG. 14 is a perspective view of a state in which the state in which the first fixing part is provided and inspected by the vision inspector according to embodiments;

FIG. 15 is a flowchart of a method of manufacturing a secondary battery according to embodiments;

FIG. 16 is a plan view of a state in which a fixing part is provided in an electrode assembly according to other embodiments;

FIG. 17 is a side view of the electrode assembly according to other embodiments;

FIG. 18 is a plan view of a state in which a plurality of suture lines are provided in the electrode assembly according to other embodiments;

FIG. 19 is a side view of a state in which the plurality of suture lines are provided in the electrode assembly according to other embodiments;

FIG. 20 is a plan view of a state in which the suture lines are continuously provided in the electrode assembly in a width direction according to other embodiments;

FIG. 21 is a cross-sectional view of one end of the electrode assembly in a longitudinal direction according to other embodiments;

FIG. 22 is a cross-sectional view of the other end of the electrode assembly in the longitudinal direction according to other embodiments;

FIG. 23 is a cross-sectional view of a state in which a heat-resistant thread is sewn upward from a lower side of the electrode assembly according to other embodiments;

FIG. 24 is a cross-sectional view of a state in which the heat-resistant thread moves in a horizontal direction from the upper side of the electrode assembly and then is sewn again downward according to other embodiments;

FIG. 25 is a cross-sectional view of a state in which the heat-resistant thread is sewn again to the upper side of the electrode assembly according to other embodiments;

FIG. 26 is a cross-sectional view of a state in which the heat-resistant thread moves in the horizontal direction from the upper side of the electrode assembly according to other embodiments;

FIG. 27 is a cross-sectional view of a state in which the heat-resistant thread moves downward from the upper side of the electrode assembly and then is rewound in the horizontal direction according to other embodiments;

FIG. 28 is a cross-sectional view of a state in which the heat-resistant thread is sewn to the upper side of the electrode assembly along the heat-resistant thread installed in a vertical direction according to embodiments;

FIG. 29 is a cross-sectional view of a state in which the heat-resistant thread moves in the horizontal direction from the upper side of the electrode assembly according to other embodiments;

FIG. 30 is a cross-sectional view of a state in which the heat-resistant thread moves to the upper side of the electrode assembly along the heat-resistant thread installed in the vertical direction and then is sewn to the lower side of the electrode assembly according to embodiments;

FIGS. 31A and 31B are perspective views of a battery pack including a secondary battery according to embodiments; and

FIGS. 32A and 32B are perspective and side views of a vehicle including a battery pack according to embodiments.

### DETAILED DESCRIPTION

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

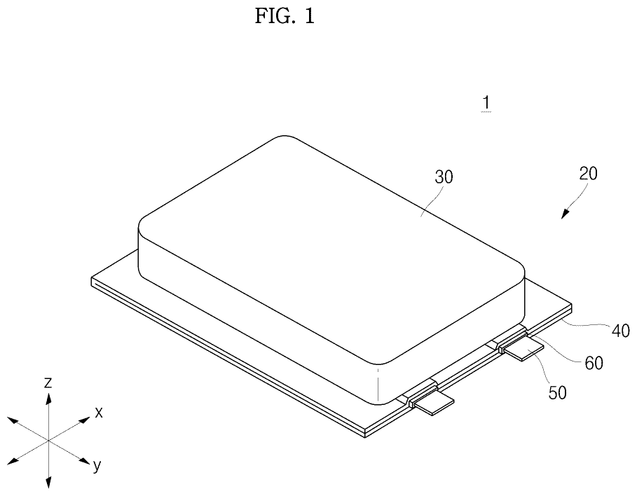

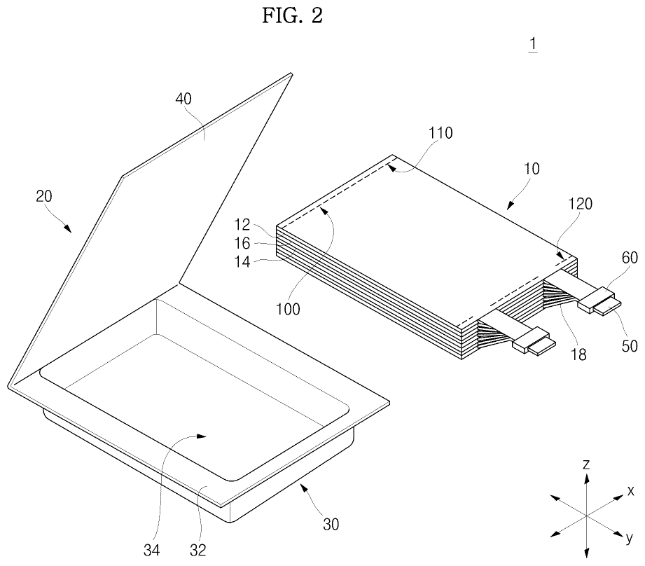

FIG. 1 is a perspective view of a secondary battery 1 according to embodiments, and FIG. 2 is a perspective view of a state in which an electrode assembly 10 is separated from a case 20 according to embodiments. As illustrated in FIGS. 1 and 2, the secondary battery 1 according to embodiments may include the electrode assembly 10 and a fixing part 100. In some embodiments, the secondary battery 1 may further include at least one of the case 20, an electrode lead 50, and an insulating tape 60.

In the present disclosure, because a separator 16 that does not face a positive electrode plate 12 and a negative electrode plate 14 is fixed by sewing curling of the separator 16, which thereby make the secondary battery 1 safer.

The electrode assembly 10 may include the positive electrode plate 12, the negative electrode plate 14, and the separator 16. The electrode assembly 10 may be provided as a stacked or wound type. For example, the stacked type electrode assembly 10 may have a structure in which a positive electrode plate 12, a negative electrode plate 14, and a separator 16 are alternately stacked. In other embodiments, a wound type electrode assembly 10′ may be provided in the form of a roll in which a negative electrode part, a positive electrode part, and a separator 16 are wound.

The electrode assembly 10 according to embodiments may be provided with an electrode tab 18, which is accommodated in the case 20 and is provided with the positive electrode plate 12, the negative electrode plate 14, and the separator 16 disposed between the positive electrode plate 12 and the negative electrode plate 14. In the present disclosure, the case 20 may be referred to as a pouch.

The electrode assembly 10 may be accommodated inside the pouch together with an electrolyte. Here, the electrolyte may a lithium salt such as LiPF6, LibF4, etc., in an organic solvent such as ethylene carbonate (EC), propylene carbonate (PC), diethyl carbonate (DEC), ethyl methyl carbonate (EMC), dimethyl carbonate (DMC), etc.

The positive electrode plate 12 may be provided with a positive electrode tab 18 electrically connected to a positive electrode non-coating portion, and the negative electrode plate 14 may be provided with a negative electrode tab 18 electrically connected to a negative electrode non-coating portion. The electrode tab 18 may be welded to the electrode lead 50 and electrically connected to outside of the battery. The insulating tape 60 may be attached to the electrode lead 50 for insulation from the pouch.

The positive electrode plate 12 may be provided in the form of a plate made of aluminum (Al) and coated with transition metal oxide on at least one surface of the positive electrode plate 12. In some embodiments, a positive electrode non-coating portion, where the positive electrode active material is not applied, may be provided at one side of the positive electrode plate 12.

The negative electrode plate 14 may be provided in the form of a plate made of copper (Cu) or nickel (Ni) and be coated with a negative electrode active material such as graphite or carbon on at least one surface of the negative electrode plate 14. In some embodiments, a negative electrode non-coating portion, where the negative electrode active material is not applied, may be provided at one side of the negative electrode plate 14.

The separator 16 may be made of polyethylene (PE) or polypropylene (PP), but the present disclosure is not limited to such examples. The separator 16 may prevent electrical short between the positive electrode plate 12 and the negative electrode plate 14 and enable only movement of lithium ions.

The case 20 may be formed into various shapes such that it surrounds the outside of the electrode assembly 10. In the present disclosure, the case 20 may be a pouch made of a soft film. The pouch may be provided with a case body 30 and a case cover by folding a rectangular film extending in a longitudinal direction (y direction shown in FIG. 2).

After the electrode assembly 10 is accommodated in a recess 34 provided in the case body 30, the case cover 40 may be rotated to cover an opening of the case body 30. In the present disclosure, the pouch is not limited to the integrated form in which the case body 30 and the case cover 40 are a single film. However, for convenience, the following description will be given as an example in which the case body 30 and the case cover 40 are a single rectangular film.

In some embodiments, the case body 30 may include the recess 34 and a sealing part 32. The case body 30 may be provided with the recess 34 in which the electrode assembly 10 is accommodated at an approximate center of the recess 34. The case body 30 may include the sealing part 32 extending outward from three sides of the recess 34.

The sealing part 32 may be a surface that is parallel to and coupled to the case cover 40. For example, if the case body 30 and the case cover 40 are provided as separate members, the sealing part 32 may extend outward from the four sides of the recess 34. In some embodiments where the case body 30 and the case cover 40 are integrated with each other, the sealing part 32 may extend outward from the four sides of the recess 34.

The case cover 40 and the case body 30 may be provided as a multilayer thin film including a metal thin film and insulating layers that are disposed on one side and the other side of the metal thin film. The case cover 40 and the case body 30 may define surfaces that are in contact with each other as inner surfaces and opposite surfaces that are outer surfaces.

The recess 34 of the case body 30 may be sized to accommodate the electrode assembly 10 through pressing or drawing processing, etc. In the case body 30, an edge of the recess 34 and an edge of the case cover 40 may be thermally fused to each other after the case cover 40 covers the portion in which the recess 34 is defined. The pouch may be sealed by sealing an edge area of the case body 30 and an edge area of the case cover 40 after the electrode assembly 10 is accommodated in the recess 34.

For convenience herein, the edge of the case body 30 disposed on the outer side of a plane with respect to the recess 34 that is sealed with the edge of the case cover 40 is defined as the sealing part 32. An inner surface of the pouch may have a thermal fusion layer made of a thermal fusion material.

The case cover 40 may have a rectangular flat shape. The case cover 40 may be connected to the case body 30 to cover an upper portion of the case body 30 by a folding operation.

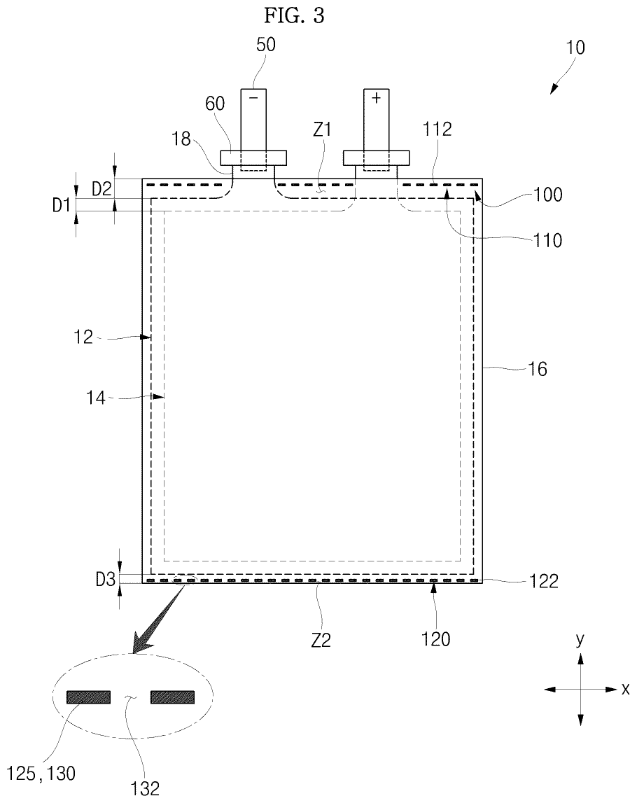

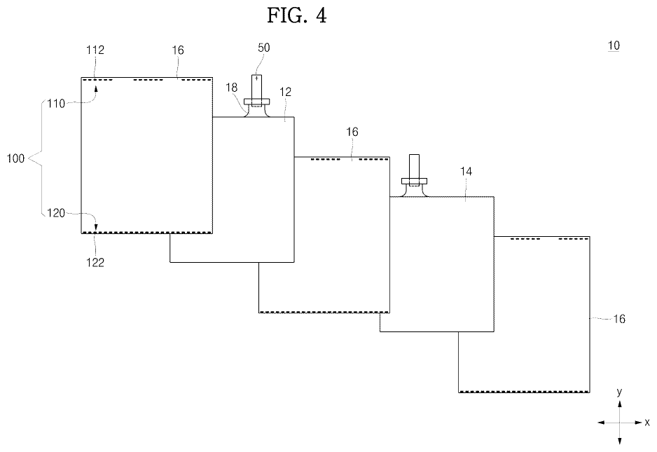

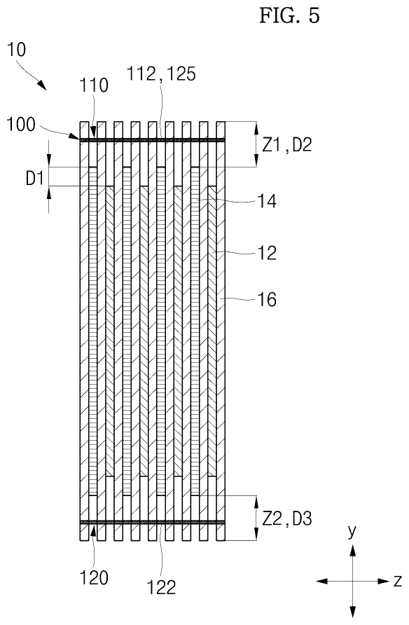

FIG. 3 is a plan view of a state in which the electrode assembly 10 is fixed by the fixing part 100 according to embodiments, FIG. 4 is an exploded perspective view of the electrode assembly 10 according to embodiments, and FIG. 5 is a side view of a state in which the electrode assembly 10 is fixed by the fixing part 100 according to embodiments. As illustrated in FIGS. 3 to 5, one side of the electrode lead 50 may be electrically connected to the electrode tab 18 of the electrode assembly 10 and the other side of the electrode lead 50 may extend to outside of the case 20.

The insulating tape 60 may be disposed between the electrode lead 50 and the case 20 and may be formed in various shapes so as to fixed to the outside of the electrode lead 50. The insulating tape 60 may be provided on each of both surfaces of the electrode lead 50 facing the case 20. Because the insulating tape 60 is provided, electrical connection between the electrode lead 50 and the case 20 may be blocked.

A stacked electrode assembly 10 will be described as an example. The separator 16 and the positive electrode plate 12 and the separator 16 and the negative electrode plate 14 may be sequentially stacked. The negative electrode plate 14 may be larger than the positive electrode plate 12. In some embodiments, the separator 16 may be larger than the negative electrode plate 14.

The electrode lead 50 and the electrode tab 18 may be disposed at one side of the electrode assembly 10 in the longitudinal direction y. An upper end of the positive electrode plate 12 may be an end of the positive electrode plate 1 in the longitudinal direction y. A lower end of the positive electrode plate 12 may be the other end of the positive electrode plate 12 in the longitudinal direction y.

In the stacked electrode assembly 10, a distance between an upper end of the positive electrode plate 12 and an upper end of the negative electrode plate 14 may be set to a first length D1. A distance between an upper end of the negative electrode plate 14 and an upper end of the separator 16 may be set to a second length D2. A distance between a lower end of the negative electrode plate 14 and a lower end of the separator 16 may be set to a third length D3.

The upper end of the negative electrode plate 14 may be disposed at an upper side of the upper end of the positive electrode plate 12. An upper end of the separator 16 may be disposed at an upper side of the upper end of the negative electrode plate 14. The lower end of the negative electrode plate 14 may be disposed at a lower side of the lower end of the positive electrode plate 12. The lower end of the separator 16 may be at a lower side of the lower end of the negative electrode plate 14.

The second length D2 may be longer than the first length D1, and the first length D1 may be longer than the third length D3. In a specific example, the first length D1 may be about 1.2 mm, the second length D2 may be about 1.5 mm, and the third length D3 may be about 1.05 mm. But these numerical parameters of the first length D1, the second length D2, and the third length D3 are only an example, and various modifications are possible depending on the size of the secondary battery 1.

The fixing part 100 may sew the plurality separators 16 (which are stacked in a vertical direction z) to restrict movement of the separators 16. The fixing part 100 may be provided in a first area Z1 and a second area Z2 that do not face the negative electrode plate 14 and the positive electrode plate 12 so as not to interfere with the negative electrode plate 14 and the positive electrode plate 12.

The first area Z1 may be defined at a first side of the separator 16 in the longitudinal direction y, and the second area Z2 may be defined at the opposite (second) side of the separator 16 in the longitudinal direction y. The first area Z1 may be an area between the upper end of the negative electrode plate 14 and the upper end of the separator 16. The second area Z2 may be an area between the lower end of the negative electrode plate 14 and the lower end of the separator 16. The first area Z1 and the second area Z2 may extend in the width direction x of the separator 16. The first area Z1 and the second area Z2 may be installed to face each other. The first area Z1 may be defined at the upper side of the separator 16, and the second area Z2 may be defined at the lower side of the separator 16.

The first area Z1 and the second area Z2 may not face the negative electrode plate 14 and the positive electrode plate 12 in the vertical direction z. Thus, the fixing part 100 may be a heat-resistant thread that is sewn the first area Z1 and the second area Z2 to connect the plurality of separators 15 and restrict the movement of the separators 16.

The fixing part 100 may be provided at an edge of the electrode assembly 10. Various are possible for sewing and fixing the separator 16, which is not in direct contact with the positive electrode plate 12 and the negative electrode plate 14. According to some embodiments, the fixing part 100 may sew and fix the separator 16 in the vertical direction z. The electrode assembly 10 may have a structure in which the plurality of separators 16 are stacked. The separators 16 provided on the outside and inside of the electrode assembly 10 may be connected by using the heat-resistant thread 125. In the event of an external force such as when the secondary battery including the electrode assembly is dropped, the plurality of separators 16 remain connected by the heat-resistant thread 125 to prevent movement of the separators 16, thereby reducing a risk of short circuit. In some embodiments, the use of the tape may be eliminated by replacing the tape function with the sewing/heat-resistant thread. In other embodiments, a thickness of the tape material may be reduced, and, thus, an energy density may increase in based on increased thickness, width, and/or length of the electrode assembly 10.

In at least one of the first area Z1 or the second area Z2 in which only the separator 16 provided, the sewing using the heat-resistant thread 125 may be performed to prevent curling of the separator 16 and prevent contact between the positive electrode plate 12 and the negative electrode plate 14. Thus, short circuiting may be prevented.

The fixing part 100 may sew the separator 16 using the heat-resistant thread 125. In some embodiments, the heat-resistant thread 125 may be made of aramid fibers, polyimide fibers, or glass fibers. To prevent the heat-resistant thread 125 from being shrunk at a temperature of about 140° C. and about 150° C. (when the separator 16 may shrink), a melting point of the heat-resistant thread 125 may be at least 150° C. or more. The heat-resistant thread 125 may be formed from a material having thermal conductivity of about 0.020 W/mk to about 0.040 W/mk (at about 20° C.).

A thickness of the heat-resistant thread 125 may be less than about 1.0 mm excluding a thickness (about 0.5 mm) of a first guide (which will be described later), if the first length D1, which is a length of the first area Z1 in the vertical direction z, is about 1.5 mm. These numerical parameters may be changed in consideration of the material of the heat-resistant thread 125 and the size of the electrode assembly 10.

The fixing part 100 may include a first fixing part 110 and a second fixing part 120. The first fixing part 110 may be disposed between the upper end of the negative electrode plate 14 and the upper end of the separator 16, and various modifications are possible for sewing and fixing the separator 16. The second fixing part 120 may be disposed between the lower end of the negative electrode plate 14 and the lower end of the separator 16, and various modifications are possible for sewing and fixing the separator 16.

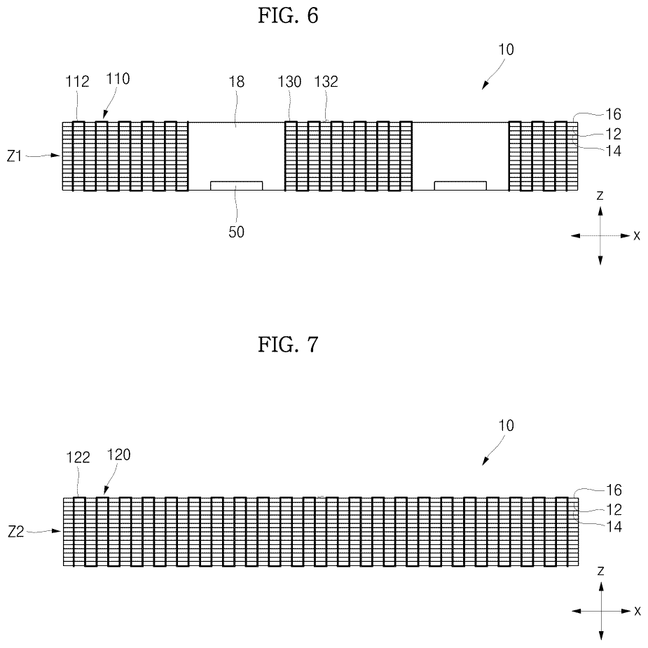

FIG. 6 is a side view of a state in which the first fixing part 110 is provided according to embodiments. As illustrated in FIG. 3 and FIG. 6, the first fixing part 110 is provided in the first area Z1 may provide a first suture line 112 in the width direction x of the separator 16. The first suture line 112 may provide a suture line in the width direction x of the electrode assembly 10, and various modifications possible. The first suture line 112 provided by sewing the heat-resistant thread 125 to the separator 16 may be provided in various shapes depending on a sewing method.

The first fixing part 110 may be positioned to avoid where the electrode tab 18 is positioned. The sewing may be performed only on the separator 16 and may be performed on only the separator 16 so as to avoid the negative electrode plate 14 and the positive electrode plate 12.

The separator 16 may be sewn using the heat-resistant thread 125 by repeatedly moving upward from the upper side of the electrode assembly 10 to move a set length in the width direction x and then moving to the lower side of the electrode assembly 10 to move a set length in the width direction x. The heat-resistant thread 125 may move in a zigzag shape on the first area Z1 to sew the separator 16, thereby installing the first sewing line 112.

FIG. 7 illustrates a side view of a state in which a second fixing part 120 is provided according to embodiments. As illustrated in FIG. 3 and FIG. 7, the second fixing part 120 may include a third suture line 122 that extends in the width direction x of the electrode assembly 10 to fix the separator 16. The second fixing part 120 may be provided in the second area Z2 to sew the heat-resistant thread 125 in the width direction x of the separator 16.

In the same manner as the first suture line 112, the third suture line 122 may be provided on the second area Z2 by sewing of the heat-resistant thread 125 moves. The third suture line 122 may be defined by alternately providing the sewing lines 130 along which the heat-resistant thread 125 is disposed and a separation line 132 along which there is no heat-resistant thread 125. For example, if a length of the third suture line 122 in the width direction x is about 46 m, a length in the width direction x of each of the sewing line 130 and the separation line 132 may be about 1 mm. These numerical parameters are for illustrative purposes only and the present disclosure is not limited to these examples.

The first suture line 112 may also be installed in the same manner as the third suture line 122, and the first suture line 112 may not be provided in the area in which the electrode tab 18 is disposed to avoid the interference.

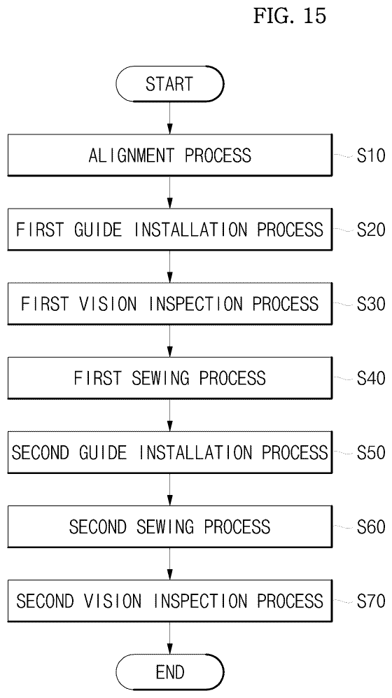

FIG. 15 is a flowchart of a method for manufacturing a secondary battery 1 according to embodiments. As illustrated in FIG. 15, the method of manufacturing the secondary battery 1 according to some embodiments may include an alignment process S10, a first guide installation process S20, a first vision inspection process S30, a first sewing process S40, a second guide installation process S50, a second sewing process S60, and a second vision inspection process S70.

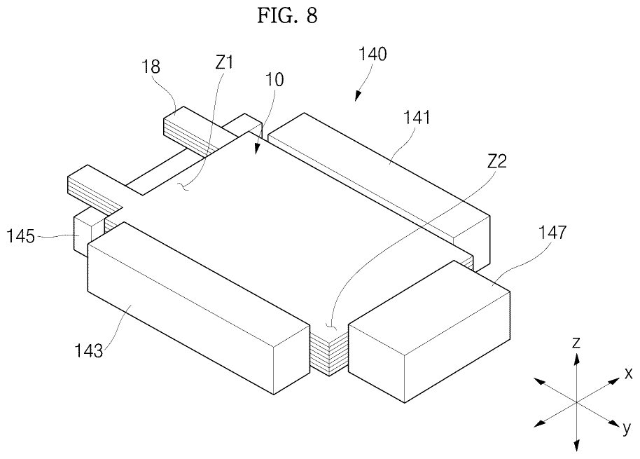

FIG. 8 is a perspective view illustrating a state in which an electrode assembly 10 is aligned by a guide jig 140 according to embodiments, and as illustrated in FIGS. 8 and 15. In the alignment process S10, the guide jig 140 is provided to the outside an electrode assembly including a positive electrode plate 12, a negative electrode plate 14, and a separator 16, with the guide jig 140 restricting movement of the electrode assembly 10 and aligning the electrode assembly 10. In a state in which the electrode assembly 10 is disposed at a set position, the alignment process S10 of installing a fixing part 100 on the separator 16 may be performed.

The guide jig 140 may be provided in at least one of a width direction x or a length direction y of the electrode assembly 10. Various modifications may be possible for aligning the electrode assembly 10. For example, the guide jig 140 may include at least one of a first wing jig 141, a second wing jig 143, a first end jig 145, or a second end jig 147.

The first wing jig 141 may be disposed at a first side of the electrode assembly 10 in the width direction x, and the second wing jig 143 may be disposed at an opposite (second) side of the electrode assembly 10 in the width direction x. The first wing jig 141 and the second wing jig 143 may be parallel to each other with the electrode assembly 10 therebetween. The first wing jig 141 may be in contact with one side of the electrode assembly 10 in the width direction x, and the second wing jig 143 may be in contact with the other side of the electrode assembly 10 in the width direction x. The first wing jig 141 and the second wing jig 143 may be provided in various shapes, including a rectangular shape. The first wing jig 141 and the second wing jig 143 may move in a direction toward the electrode assembly 10 to align opposite sides of the electrode assembly 10 in the width direction.

The first end jig 145 may be disposed at a first side of the electrode assembly 10 in a longitudinal direction y, and the second end jig 147 may be disposed at a second (opposite) side of the electrode assembly 10 in the longitudinal direction y. The first end jig 145 may move from a front side of the electrode assembly 10 toward the electrode assembly 10 to align the front side of the electrode assembly 10. The second end jig 147 may move from a rear side of the electrode assembly 10 toward the electrode assembly 10 to align the rear side of the electrode assembly 10.

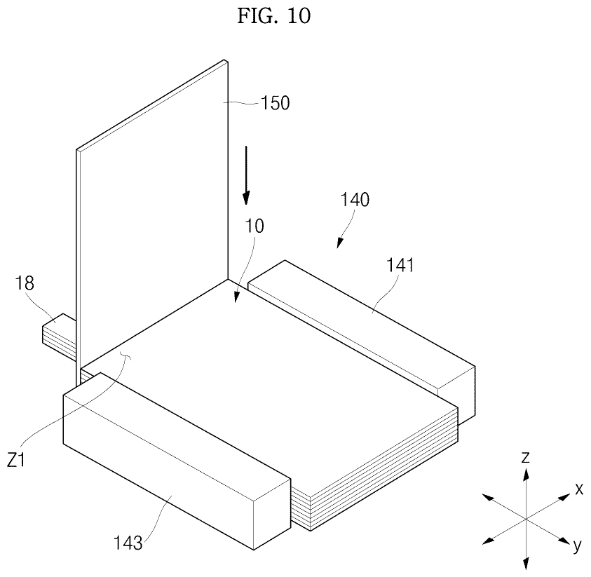

FIG. 10 is a perspective view of a state in which one side of the electrode assembly 10 in the longitudinal direction y is aligned by a first guide according to embodiments. As illustrated in FIGS. 10 and 15, the first guide installation process S20 may be a process in which the first guide 150 is positioned to face one end (left end in FIG. 10) in the longitudinal direction y of the electrode assembly 10. The first guide 150 may be various shapes and structures.

The first guide 150 may be used to restrict movement of the electrode assembly 10 when sewing the fixing part 100 to a first area Z1. In an example, the first guide 150 is provided in the form of a plate extending in a vertical direction z and moves in the vertical direction z to guide the electrode assembly 10. The vertical movement of the first guide 150 may accurately maintain the position of the electrode assembly 10 during the fixing operation of the separator 16 and to minimize displacement of the separator 16 during the sewing.

To avoid an interference with the electrode tab 18, the first guide 150 may have a groove defined in an area in which an electrode tab 18 is disposed. The groove of the first guide 150 may prevent the electrode tab 18 from being damaged or deformed by the guide such that the electrical performance of the electrode assembly 10 may be maintained. To prevent the separator 16 from being pushed during the sewing operation that provides the fixing part 100, the first guide 150 may descend to the front of the separator 16.

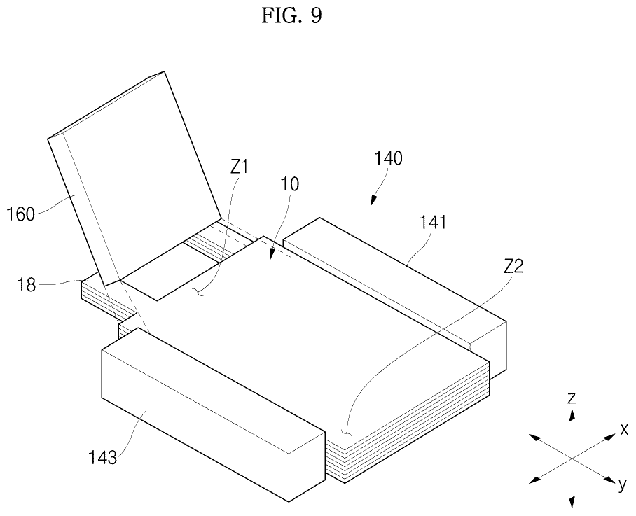

FIG. 9 is a perspective view of a state in which a first area Z1 is inspected by a visual inspector 160 according to embodiments. As illustrated in FIGS. 9 and 15, before the first sewing process (S40), the first visual inspection process S30 is performed so that both sides of the electrode assembly 10 in the longitudinal direction y are inspected. For example, the first visual inspection process S30 may be performed between the alignment process S10 and the first guide installation process S20 or between the first guide installation process S20 and the first sewing process S40.

In the first visual inspection process S30, coordinates of the electrode assembly 10 may be identified through a visual system and sewing coordinates may be recognized so that the positive electrode plate 12 and the negative electrode plate 14 are avoided during the sewing process and the sewing is performed only on the separator 16. When performing the sewing operation and performing the visual inspection after the sewing operation is completed, a heat-resistant thread 125 containing a pigment may be used make detection of the fixing part 100 easier. The heat-resistant thread 125 containing the pigment may enable the detection based on a color difference recognized by the visual system As such, accuracy in the position of the fixing part 100 and sewing can be ensured.

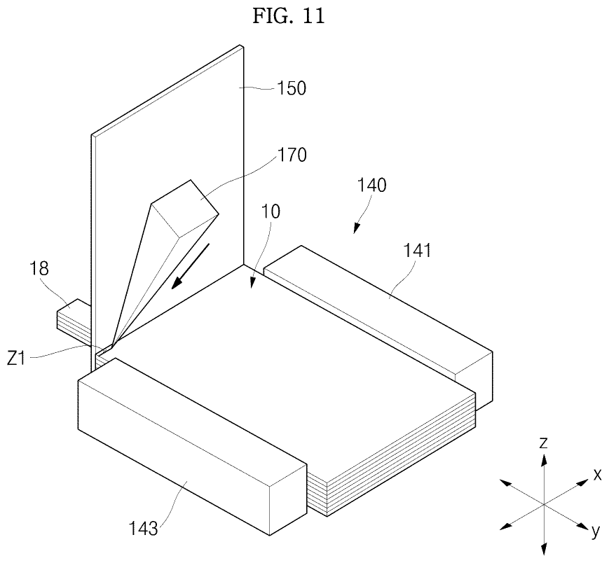

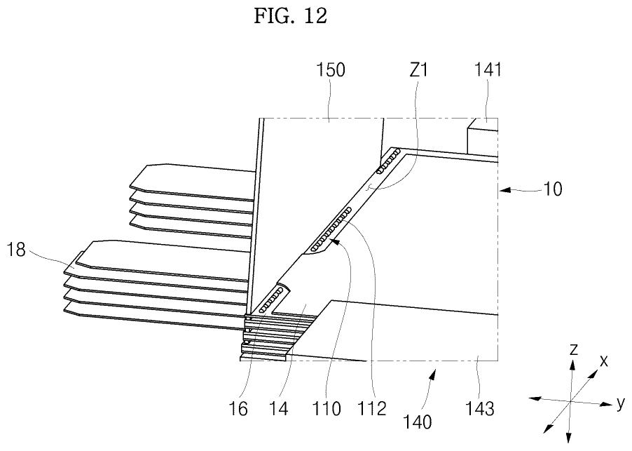

FIG. 11 is a perspective view of a state in which the electrode assembly is sewn by a sewing machine 170 in the first area Z1 according to embodiments, and FIG. 12 is a perspective view of a state in which the first fixing part 110 is provided in the first area Z1 according to embodiments. As illustrated in FIGS. 11, 12, and 15, the first sewing process S40 may fix one side of the separator 16 that does not directly face the positive electrode plate 12 and the negative electrode plate 14 by the sewing in the longitudinal direction y. For example, the first sewing process (S40) may sew the separator 16 disposed in the first area Z1 between one end of the negative electrode plate 14 in the longitudinal direction y and one end of the separator 16 in the longitudinal direction y.

The sewing machine 170 may move in the width direction x of the electrode assembly 10 along the first area Z1 and may provide the first fixing part 110 having a first sewing line 112 in the first area Z1. The movement of the sewing machine 170 may be controlled at a constant speed and pressure, which allows the accuracy and consistency of the sewing operation to be maintained. Various types of sewing devices for sewing the plurality of stacked separators 16 in the vertical direction z using the heat-resistant thread 125 may be used as the sewing machine 170.

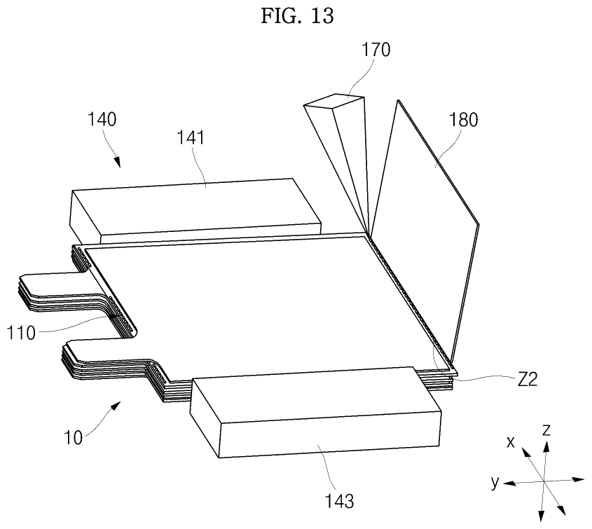

FIG. 13 is a perspective view of a state in which the electrode assembly in a second area Z2 is sewn by the sewing machine 170 according to embodiments. As illustrated in FIGS. 13 and 15, in the second guide installation process S50 a second guide 180 is provided at a position facing the other end of the electrode assembly 10 in the longitudinal direction y. The second guide 180 may stably fix the electrode assembly 10 together with the first guide 150 to improve the accuracy of the sewing operation.

When providing the second guide 180, the first guide 150 may also be provided, or only the second guide 180 may be provided. The provision of the second guide 180 may minimize positional changes in the electrode assembly 10 during the sewing and maintain consistency of the sewing line by fixing the other end of the electrode assembly 10 in the longitudinal direction y. The second guide 180 fixes the other end of the electrode assembly 10 in the longitudinal direction y to prevent distortion or movement of the electrode assembly 10 that may occur after the second sewing operation. The second guide may be in the form of a square plate and may be movable vertically. In embodiments, the second guide 180 may be formed into various shapes and structures and may be installed in an automated manner as necessary.

The second sewing process S60 may fix the other side of the separator 16, which does not directly face the positive electrode plate 12 and negative electrode plate 14 by the sewing, in the longitudinal direction y. For example, in the second sewing process S60, the separator 16 disposed in the second area Z2 between the end of the negative electrode plate 14 in the longitudinal y direction and the end of the separator 16 in the longitudinal y may be sewn.

In the second sewing process S60, the second fixing part 120 corresponding to the first fixing part 110 formed in the first sewing process S40 may be formed to stably fix both sides of the separator 16 and minimize a risk of short circuit. As illustrated in FIGS. 3 and 15, in the first sewing process S40 and the second sewing process S60, a sewing line 130 in which the heat-resistant thread 125 is provided and a separation line 132 in which the heat-resistant thread 125 is not provided may be alternately disposed. The arrangement of the sewing line 130 and the separation lines 132 may control sewing strength of the separator 16 and prevent deformation of the separator 16 due to thermal expansion or contraction. In some embodiments, in the first sewing process S40 and the second sewing process S60, sewing lines 130 along which heat-resistant thread 125 is disposed may be provided continuously in the width direction x of the separator 16.

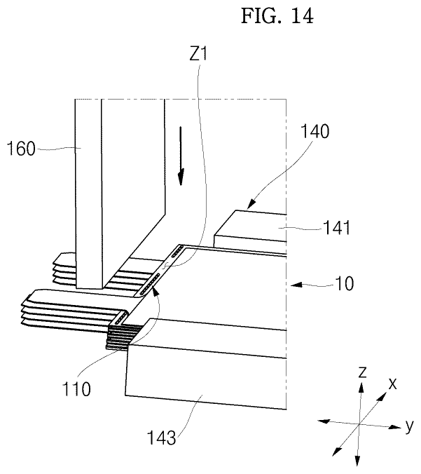

FIG. 14 is a perspective view of a state in which the first fixing part 10 is inspected by the visual inspector 160 according to embodiments. As illustrated in FIGS. 14 and 15, the second visual inspection process S70 may involve visual inspection on both sides of the electrode assembly 10 in the longitudinal direction y after the second sewing process S60. The second visual inspection process S70 may confirming whether the sewing of the fixing part 100 has been performed accurately after the sewing operation is completed. The position and consistency of the first fixing part 110 and the second fixing part 120 constituting the fixing part 100 may be inspected by the visual system to detect errors or defects that may occur during the sewing process. If the sewing position defects are found, a warning signal may be generated to enable an immediate corrective action, thereby improving quality management in the battery manufacturing process.

The second visual inspection process S70 may also be used to confirm whether the heat-resistant thread 125 used in the sewing process is properly provided. In the second vision inspection process S70, an installation status of the heat-resistant thread 125 may be inspected to evaluate whether the sewing has been performed properly. This may ensure the quality of the sewing operation and improving reliability and safety of the secondary battery 1.

In some embodiments, the vision system may perform detailed inspection by using a high-resolution camera and an image processing algorithm, and the system may evaluate various quality factors such as the positions of the first fixing part 110 and the second fixing part 120, as well as a depth of sewing and conditions of the thread. The inspection may be linked to automation of the sewing process and a quality management system to contribute to maximize production efficiency and minimize defect rates.

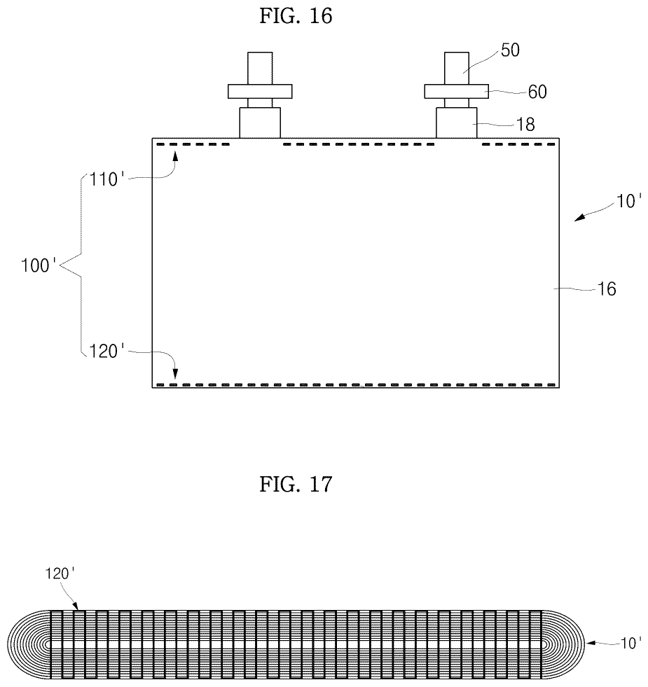

FIG. 16 is a plan view of a state in which a fixing part 100′ is provided to an electrode assembly 10′ according to other embodiments, and FIG. 17 is a side view of the electrode assembly 10′ according to other embodiments. As illustrated in FIGS. 16 and 17, the electrode assembly 10′ may be provided as a wound type of electrode assembly. In the following, a detailed description of features that are the same as in the above-described embodiments will be omitted.

An electrode lead 50 may be connected to an electrode tab 18 protruding from an upper side of the electrode assembly 10′, and an insulating tape 60 may be fixed to the outside of the electrode lead 50. The fixing part 100′ may be provided to fix the separator 16 of the electrode assembly 10′. The fixing part 100′ may include a first fixing part 110′ that fixes an upper side of the separator 16 in a width direction x, and a second fixing part 120′ that is disposed below the first fixing part 110′ and fixes the lower side of the separator 16 in the width direction x.

Because the first fixing part 110′ is not provided in an area in which the electrode tab 18 is provided, interference with the electrode tab 18 may be prevented, and electrical performance of the electrode assembly 10′ is not hindered.

The second fixing part 120′ may connect the separator 16 disposed at the lower side of the electrode assembly 10′ by sewing. When a plurality of separators 16 are stacked in a vertical direction z, the second fixing part 120′ may be sewn in the vertical direction z to effectively restrict movement of the separators 16. Because force fixing the separator 16 is increased by the first fixing part 110′ and the second fixing part 120′, a position of the separator 16 may be stably maintained even if the electrode assembly 10′ is subjected to an external impact or vibration. This may improve the durability and reliability of the electrode assembly 10′ and minimize possibility of short circuit occurring between the electrodes.

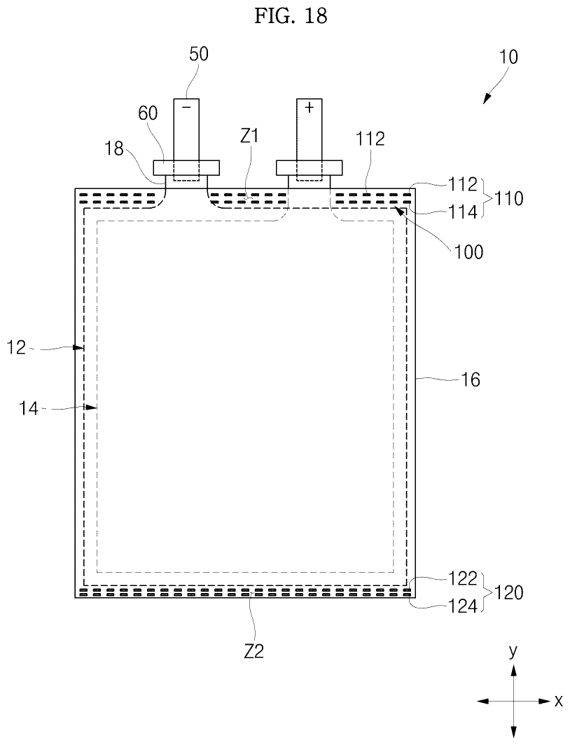

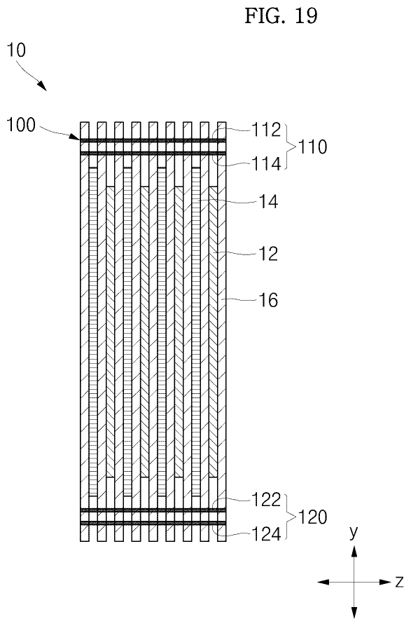

FIG. 18 is a plan view of a state in which a plurality of suture lines are provided on the electrode assembly 10 according to other embodiments, and FIG. 19 is a side view of a state in which the plurality of suture lines are provided on the electrode assembly 10 according to other embodiments. As illustrated in FIGS. 18 and 19, a fixing part 100 according to embodiments may include a first fixing part 110 and a second fixing part 120, and each of the first fixing part 110 and the second fixing part 120 may be provided with two suture lines.

The first fixing part 110 may include a first suture line 112 and a second suture line 114. The first fixing part 110 may be provided between an upper end of a negative electrode plate 14 and an upper end of a separator 16. The first suture line 112 may provide a suture line in a width direction x of the electrode assembly 10 at an upper side of the negative electrode plate 14 to fix the separator 16. The second suture line 114 may provide an additional suture line below the first suture line 112 to additionally fix the separator 16. The plurality of suture lines firmly fixes the upper end of the electrode assembly 10 to minimize movement of the separator 16, for example, in the event of an external impact or vibration and reduces a risk of electrical short circuit between the electrodes.

The second fixing part 120 may include a third suture line 122 and a fourth suture line 124. The second fixing part 120 may be provided between a lower end of the negative electrode plate 14 and a lower end of the separator 16. The third suture line 122 may provide a suture line in a width direction x of the electrode assembly 10 at a lower side of the negative electrode plate 14 to fix the separator 16. The fourth suture line 124 may provide an additional suture line below the third suture line 122 to additionally fix the separator 16. The plurality of suture lines of the second fixing part 120 may more stably fix the separator 16 at the lower side of the electrode assembly 10, thereby improving the durability and reliability of the entire electrode assembly 10 and suppressing structural deformation that may occur during long-term use. Four suture lines also may play an important role in maximizing the structural stability of the electrode assembly 10 and ensuring electrical performance by firmly fixing each of the upper and lower ends of the separator 16. In some embodiments, the plurality of suture lines may be used to prevent deformation of the separator 16 due to thermal expansion or contraction.

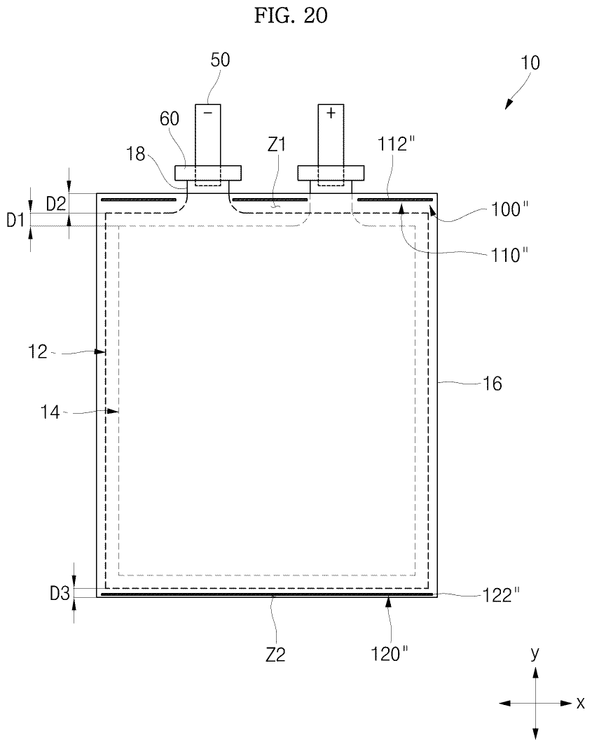

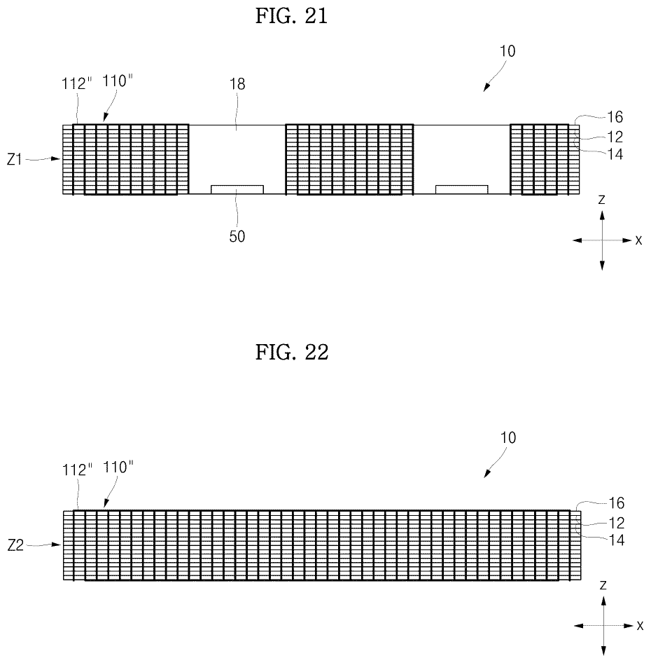

FIG. 20 is a plan view of a state in which the suture lines 130 are continuously installed on the electrode assembly 10 in a width direction x according to other embodiments, FIG. 21 is a cross-sectional view of one end of the electrode assembly 10 in a longitudinal direction y according to other embodiments, and FIG. 22 is a cross-sectional view of the other end of the electrode assembly 10 in the longitudinal direction y according to other embodiments. As illustrated in FIGS. 20 to 22, a fixing part 100″ may include a first fixing part 110″ and a second fixing part 120″.

The first fixing part 110″ may be provided between an upper end of the negative electrode plate 14 and an upper end of the separator 16. The first suture line 112″ may provide a continuous suture line in the width direction x of the electrode assembly 10 at an upper side of the negative electrode plate 14 to fix the separator 16. The straight suture line may improve the structural stability of the electrode assembly 10 in the event of an external impact. In addition, the straight sewing line 130 may restrict movement of the separator 16 to optimize electrical performance and minimize a risk of an occurrence of short circuiting.

The first fixing part 110″ may be provided in an area in which an electrode tab 18 is not provided. In a sewing operation of the first suture line 112″, the sewing operation repeatedly returning to an intermediate position at which the sewing of a heat-resistant thread 125 is performed to provide a straight suture line on the first area Z1 in the width direction x. This repetitive sewing operation may increase in strength of the sewing line to allow the electrode assembly 10 to be maintained in consistent performance even if used for a long period of time. In some embodiments, the repetitive sewing may distribute a pressure evenly along the sewing line to prevent the structural deformation due to the thermal expansion or contraction.

The second fixing part 120″ may be provided between a lower end of the negative electrode plate 14 and a lower end of the separator 16. The third suture line 122″ may provide a continuous suture line in the width direction x of the electrode assembly 10 at a lower side of the negative electrode plate 14 to fix the separator 16. The third suture line 122″ formed by the same sewing method as the first suture line 112″. In a sewing operation of the third suture line 122″, the sewing operation of repeatedly returning to an intermediate position at which the sewing of a heat-resistant thread 125 is performed provides a straight suture line on the second area Z2 in the width direction x. As a result, the lower sides of the separators 16 may also be firmly fixed, and electrical performance and structural stability may be maintained.

The sewing of the first fixing part 110″ will be described in more detail.

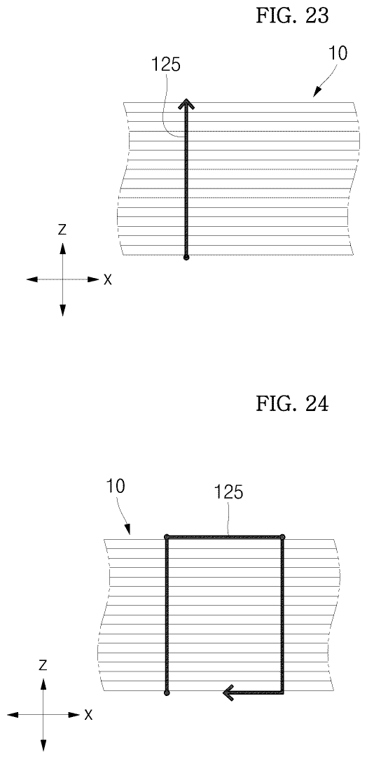

FIG. 23 is a cross-sectional view of a state in which a heat-resistant thread 125 is sewn upward from a lower side of the electrode assembly according to other embodiments. As illustrated in FIG. 23, a starting point of the heat-resistant thread 125 may be at a lower side of the electrode assembly 10, and the heat-resistant thread 125 may be sewn in a direction to an upper side of the electrode assembly 10.

FIG. 24 is a cross-sectional view of a state in which the heat-resistant thread 125 moves in a horizontal direction from the upper side of the electrode assembly 10 and then is sewn downward. As illustrated in FIG. 24, an end of the heat-resistant thread 125 that extends into an upper space of the electrode assembly 10 may move in a direction in which the sewing is performed by a first set length and then move again to the lower side of the electrode assembly 10. The end of the heat-resistant thread 125 in the lower space of the electrode assembly 10 may move by a second set length in a direction opposite to the horizontal direction in which the sewing is previously performed. The first setting length may be greater than the second setting length.

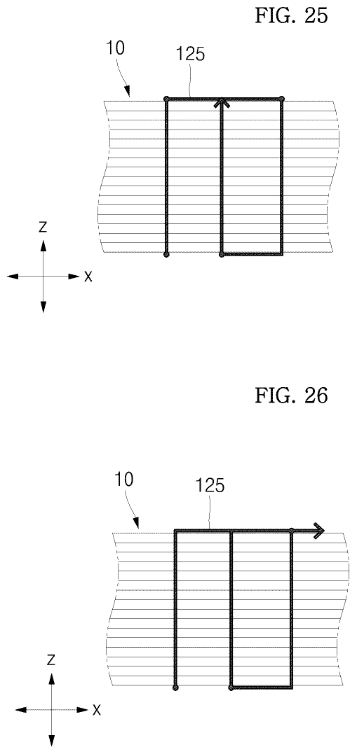

FIG. 25 is a cross-sectional view of a state in which the heat-resistant thread 125 is sewn again to the upper side of the electrode assembly 10 according to other embodiments. As illustrated in FIG. 25, the heat-resistant thread 125 may be sewn a second time to the upper side of the electrode assembly 10. Thus, the sewing is performed at a position that is in contact with a portion of the heat-resistant thread 125 sewn to the upper side of the electrode assembly 10. This sewing method may create a section that overlaps the existing sewing line to thereby increase in fixing strength and help to stably maintain the position of the separators 16.

FIG. 26 is a cross-sectional view of a state in which the heat-resistant thread 125 moves in the horizontal direction from the upper side of the electrode assembly 10 according to other embodiments. As illustrated in FIG. 26, an end of the heat-resistant thread 125 extending to the upper space of the electrode assembly 10 may move in a direction in which the sewing is performed by the first set length. The sewing operation may be performed such that the heat-resistant thread 125 overlaps the second set length at an upper side of the electrode assembly 10. This configuration may improve the force by the separators 16 are fixed, and consistency and reliability of the sewing may be improved by overlapping the heat-resistant thread 125.

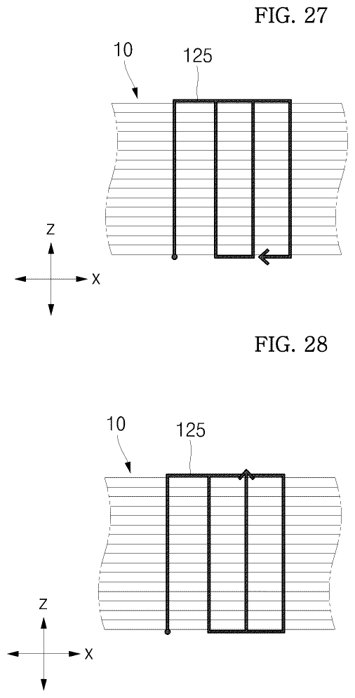

FIG. 27 is a cross-sectional view of a state in which the heat-resistant thread 125 moves downward from the upper side of the electrode assembly 10 and then is rewound in the horizontal direction according to other embodiments. As illustrated in FIG. 27, an end of the heat-resistant thread 125 that moves by the first set length may move again to the lower side of the electrode assembly 10. In some embodiments, the end of the heat-resistant thread 125 in the lower space of the electrode assembly 10 may move in a direction opposite to the direction in which sewing is performed by the second set length. This rewinding sewing method causes the separators 16 of the electrode assembly 10 to be firmly fixed, thereby improving durability and preventing deterioration of electrical performance.

FIG. 28 is a cross-sectional view of a state in which the heat-resistant thread 125 is sewn to the upper side of the electrode assembly 10 in a vertical direction z according to embodiments. As illustrated in FIG. 28, because the heat-resistant thread 125 is sewn to the upper side of the electrode assembly 10 a second time, the sewing may be performed to a position that is in contact with a portion of the heat-resistant thread 125 that is sewn to the upper side of the electrode assembly 10. In addition, because the heat-resistant thread 125 overlaps the previously sewn heat-resistant thread 125 0, the fixing of the plurality of separators 16 fixed by the heat-resistant thread 125 may be more firmly achieved.

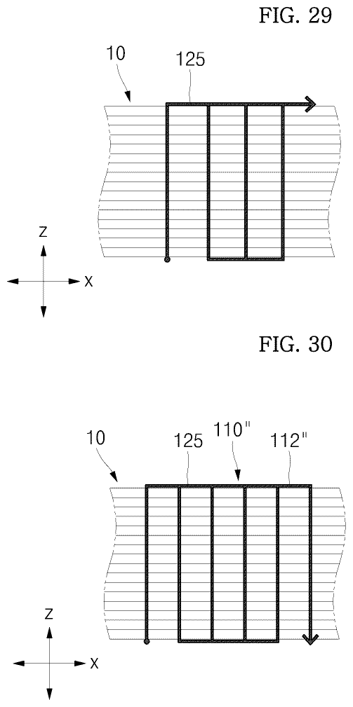

FIG. 29 is a cross-sectional view of a state in which the heat-resistant thread 125 moves in the horizontal direction from the upper side of the electrode assembly 10 according to other embodiments. As illustrated in FIG. 29, an end of the heat-resistant thread 125 that has moved to the upper space of the electrode assembly 10 may move again in the horizontal direction in which sewing is performed. In some embodiments, the sewing may be performed such that the heat-resistant thread 125 overlaps the second set length at the upper side of the electrode assembly 10. This repeated overlapping sewing method may further improve the strength of the sewing and maintain a stable structure even after long-term use.

FIG. 30 is a cross-sectional view of a state in which the heat-resistant thread 125 moves to the upper side of the electrode assembly 10 along the heat-resistant thread 125 provided in the vertical direction z and then is sewn to the lower side of the electrode assembly 10 according to embodiments. As illustrated in FIG. 30, an end of the heat-resistant thread 125 that has moved in the sewing direction from the upper side of the electrode assembly 10 may move again to the lower side of the electrode assembly 10. Because the sewing of the separators 16 provided in the electrode assembly 10 is performed in the above manner, the separators 16 may be more firmly fixed. The repetitive sewing operation may contribute to improve the reliability of the sewing and optimize the durability and electrical performance of the electrode assembly 10.

The electrode assembly 10 according to the present disclosure will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X₆O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GeO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂GbO₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

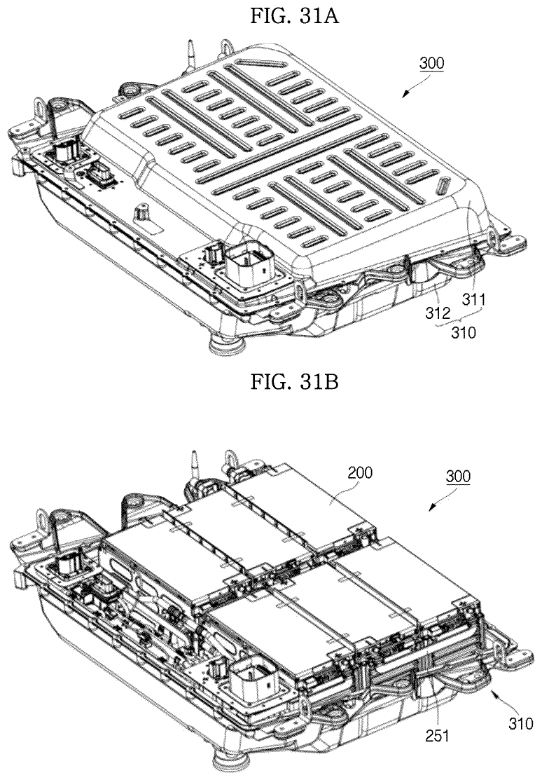

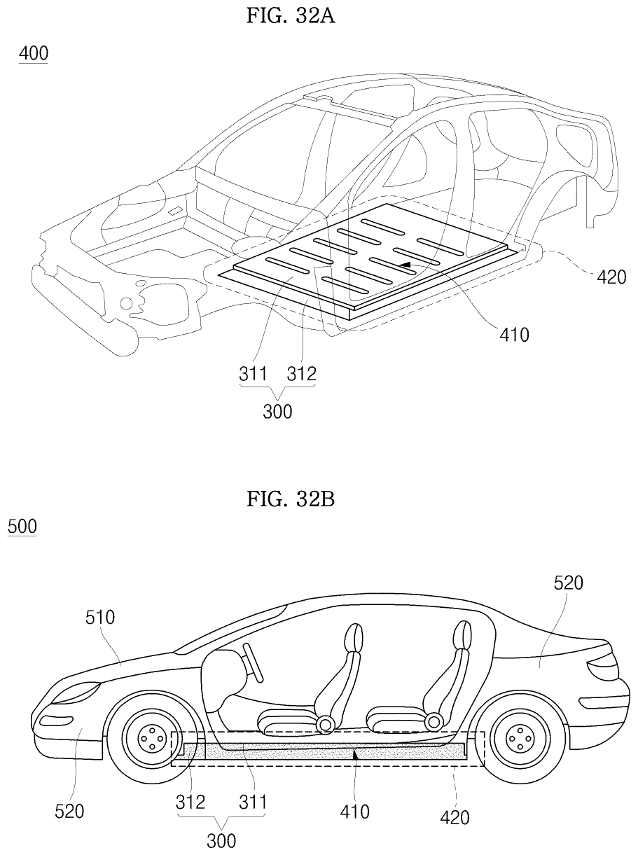

The batteries according to the above-described embodiments may be used to manufacture a battery pack. FIGS. 31A and 31B are perspective views showing a battery pack including the exemplary secondary battery 1 according to the present disclosure. Referring to FIGS. 31A and 31B, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles. FIGS. 32A and 32B are, respectively, a perspective view and a side view showing vehicles 400 and 500 including the exemplary battery pack 300 according to the present disclosure.

In FIG. 32A, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 32B, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

According to some embodiments, the separator may be fixed in the sewing manner to more effectively restrict the movement of the separator than the tape fixing manner, thereby improving the electrical stability of the secondary battery.

According to some embodiments, because the separator is fixed in the sewing manner, the movement of the separator may be restricted even under the external impact to significantly reduce the risk of the short circuit inside the secondary battery.

However, the effects obtainable through the present disclosure are not limited to the effects described above, and other technical effects that are not mentioned will be clearly understood by those skilled in the art from the description of the invention described below.

Although a few embodiments of the present disclosure have been shown and described, it would be appreciated by those skilled in the art that various changes and modifications may be made in this embodiment without departing from the principles and spirit of the disclosure.

What is claimed is:

1. A secondary battery comprising:
an electrode assembly including a positive electrode plate, a negative electrode plate, and a separator; and
a fixing part provided at an end of the electrode assembly, the fixing part sewing and fixing the separator at a position separated from the positive electrode plate and the negative electrode plate.

2. The secondary battery as claimed in claim 1, wherein the electrode assembly is a stack type or wound type.

3. The secondary battery as claimed in claim 1, wherein the fixing part includes a heat-resistant thread.

4. The secondary battery as claimed in claim 3, wherein the heat-resistant thread is made of aramid fibers, polyimide fibers, or glass fibers.

5. The secondary battery as claimed in claim 1, wherein the electrode assembly includes a plurality of stacked separators are stacked, and
wherein the fixing part sews and thereby fixes the separators in a vertical direction.

6. The secondary battery as claimed in claim 1, wherein the fixing part comprises a part disposed between an upper end of the negative electrode plate and an upper end of the separator to sew and fix the separator.

7. The secondary battery as claimed in claim 6, wherein the fixing part comprises a suture line in a width direction of the electrode assembly that fixes the separator.

8. The secondary battery as claimed in claim 7, wherein the suture line is a first suture line, and the fixing part further comprises a second suture line below the first suture line that further fixes the separator.

9. The secondary battery as claimed in claim 1, wherein the fixing part comprises a first fixing part disposed between an upper end of the negative electrode plate and an upper end of the separator to sew and fix the separator and a second fixing part disposed between a lower end of the negative electrode and a lower end of the separator to sew and fix the separator.

10. The secondary battery as claimed in claim 9, wherein the second fixing part comprises a suture line in a width direction of the electrode assembly to fix the separator.

11. The secondary battery as claimed in claim 10, wherein the second fixing part further comprises another suture line that further fixes the separator.

12. A method of manufacturing a secondary battery, the method comprising:
an alignment process of installing a guide jig outside an electrode assembly comprising a positive electrode plate, a negative electrode plate, and a separator so that the guide jig restricts movement of the electrode assembly;
a first guide installation process of installing a first guide to a position facing a first end of the electrode assembly in a longitudinal direction;
a first sewing process of sewing and fixing a first side of the separator in the longitudinal direction, the first side being spaced from the positive electrode plate and the negative electrode plate;
a second guide installation process of installing a second guide to a position facing a second end of the electrode assembly in the longitudinal direction; and
a second sewing process of sewing and fixing the second side of the separator in the longitudinal direction, the second side being spaced from the positive electrode plate and the negative electrode plate.

13. The method as claimed in claim 12, further comprising, before the first sewing process, a visual inspection process of visually inspecting the first and second sides of the electrode assembly.

14. The method as claimed in claim 13, wherein the visual inspection process is a first visual inspection process, and
wherein the method further comprises, after the second sewing process, a second visual inspection process of visually inspecting the first and second sides of the electrode assembly.

15. The method as claimed in claim 12, wherein the guide jig is provided on at least one of sides of the electrode assembly in a width direction or both sides of the electrode assembly in the longitudinal direction.

16. The method as claimed in claim 12, wherein the first guide is a plate extending in a vertical direction that moves vertically to guide the electrode assembly.

17. The method as claimed in claim 12, wherein, in the first sewing process, a part of the separator disposed in an area between an end of the negative electrode plate in the longitudinal direction and an end of the separator in the longitudinal direction is sewn.

18. The method as claimed in claim 12, wherein, in the second sewing process, a part of the separator disposed in an area between an end of the negative electrode plate in the longitudinal direction and an end of the separator in the longitudinal direction is sewn.

19. The method as claimed in claim 12, wherein, in the first sewing process and the second sewing process, a sewing line in which a heat-resistant thread is disposed and a separation line in which the heat-resistant thread is not disposed, are alternately formed.

20. The method as claimed in claim 12, wherein, in the first sewing process and the second sewing process, a sewing line in which a heat-resistant thread is disposed is formed in a width direction of the separator.
